(19) United States
(12) Patent Application Publication
(10) Pub. No.: US 2016/0288877 A1
(43) Pub. Date: Oct. 6, 2016

(54) BICYCLE DERAILLEUR WITH AUTOMATIC ALIGNMENT, AND METHODS FOR AUTOMATIC DERAILLEUR ALIGNMENT

(71) Applicant: WICK WERKS, LLC, OGDEN, UT (US)

(72) Inventors: Eldon L. GOATES, Colorado Springs, CO (US); David CHRISTENSEN, Colorado Springs, CO (US)

(21) Appl. No.: 15/089,178

(22) Filed: Apr. 1, 2016

Related U.S. Application Data
(60) Provisional application No. 62/141,690, filed on Apr. 1, 2015.

(51) Int. Cl. B62M 9/122

(52) U.S. Cl. CPC B62M 9/122

(57) ABSTRACT

An electronic derailleur control system for a bicycle has controller operatively connected to a derailleur of the bicycle and to at least one sensor of the bicycle, and a memory on which instructions are stored that are executable by the controller to control shifts of the derailleur. The system is receives feedback data from the sensor on a performance parameter of the bicycle, and analyzes the feedback data to evaluate performance conditions. The controller calculates adjustments to the derailleur shifts based on the performance conditions, with automatic iteration to repeatedly accept feedback and optimize the shift distance based on the feedback. The system can be activated by rider command or by satisfaction of pre-set performance conditions stored in the memory. A derailleur and a method for controlling shifts on this basis also are disclosed.

### CROSS-REFERENCE TO RELATED APPLICATIONS

Priority is claimed to U.S. Provisional Patent Application No. 62/141,690, filed on Apr. 1, 2015, the contents of which are incorporated by reference herein in their entirety.

### BACKGROUND OF THE INVENTION

This application relates to an improved bicycle derailleur. The application also relates to a bicycle derailleur having electronic controls, and an electronic control system for a bicycle derailleur. The application further relates to a method for using an electronic system for controlling a derailleur of a bicycle.

### SUMMARY OF THE INVENTION

A preferred embodiment of the device and system of the invention is a derailleur controlled by wired or wireless signals communicated between a rider's shift command actuator, mechanical derailleur controls that move parts of the derailleur, feedback sensors that sense the positions of and vibrations of and around the derailleur other bicycle parts, and a main control unit that automatically adjusts derailleur motion instructions sent to the derailleur, by applying adjustments to the instructions based on feedback data received from the sensors. As the shift occurs, the sensor detects actions of moving parts of the bicycle, and provides feedback data signals to the main control unit. The main control unit then responds to the feedback, as needed, with commands for minor derailleur adjustment until the feedback signals indicate proper derailleur position, with repeated iterations to make continuous adjustments to achieve optimum alignment without additional rider input. It is preferred that the main control unit also has a learning capability that detects and compiles action data communicated via feedback data signals generated by the sensors compared with position commands given. The invention encompasses derailleur shifting methods including steps of automated adjustment of derailleur position based on feedback from sensors, where the sensors may measure vibrations, or proximity, or relative position of components as desired—all of which can assist in indication of alignment/misalignment.

### BRIEF DESCRIPTION OF THE DRAWINGS

FIG. 1 is a side view of a bicycle drive train.

FIG. 2 is a side perspective view of a rear derailleur and a rear gear cluster with a chain engaged thereon.

FIG. 3 is a top view of a cage of a rear derailleur and a rear gear cluster with a chain engaged thereon.

FIG. 4 is a top view of a cage of a rear derailleur and a rear gear cluster.

FIG. 5 is a top view of a cage of a rear derailleur and a rear gear cluster as in FIG. 4, with the cage in a shifted position.

FIG. 6 is a schematic diagram showing a system for electronic derailleur alignment according to an embodiment of the invention.

FIG. 7 is a flow chart illustrating steps in a method for electronic derailleur alignment according to an embodiment of the invention.

### DETAILED DESCRIPTION

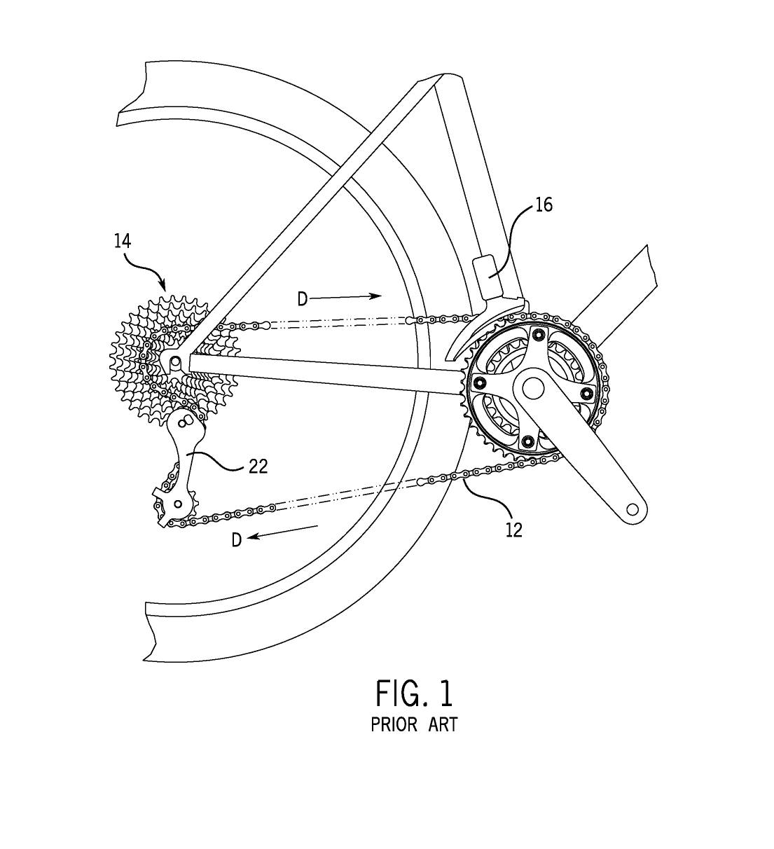

Derailleurs are used to shift multi-geared bikes using an exposed chain (roller chain or bicycle chain) and cluster of gears known as a cassette. A rear derailleur cassette 14 (also called a gear cluster, cog set, freewheel, or rear sprockets), shown in FIG. 1, is positioned at the rear wheel of the bicycle, as opposed to the front derailleur 16 positioned near the pedals. A rear derailleur controls the position of the bicycle chain 12 as it approaches the cassette 14. By moving the position of the derailleur laterally toward one side of the bicycle or the other, the chain 12 is directed to a desired sprocket of the cassette 14.

Traditional shifting is done by moving a shifter mechanism (typically on the bicycle handlebars), connected to a cable, which in turn moves the derailleur mechanism attached near the rear wheel of the bike. Older systems used a completely variable mechanism where the cyclist would move the shifter lever which would position the derailleur. Precise shifting required just the right “feel”. With these systems the cyclist would “feel” and listen for correct derailleur alignment for the gear change. More modern shifting systems (often called index shifting) include a mechanism with several stops or ratcheted positions associated with the needed cable pull of each position of the rear derailleur so that the chain will run “cleanly” to the desired cassette gear. If the derailleur and shifter mechanisms are adjusted correctly, gear changes are “clean” and the chain travels through its path without interference from other cassette sprockets. If, on the other hand, the adjustments are not correct, or if the cable wears or stretches over time, or if the mounting mechanism (derailleur hanger) is bent slightly (common problem caused by banging or tipping over the bike), then the chain will no longer run freely through its path without interference with other gears. This minor misalignment is often evidenced by a “clicking” or “tinging” sound as the cyclist pedals.

To maintain precise alignment and therefore good shifting, periodic derailleur adjustment is required to keep the shifting “clean.” The concepts for adjustment are easy to understand, however, the “feel” and the technique to balance the various adjustments are not always so easy. In general, there is a certain skill set needed to adjust the bike and make it shift perfectly under all circumstances.

Indexing shifter mechanisms common on modern bikes are designed for a specific number of rear cassette ratios: for example, 9-Speed, 10-Speed, or 11-Speed. Bikes and wheels are made with cassettes and matching shifters—which makes swapping wheels more complicated. If a wheel with a different number of cassette sprockets is put on a bike, shifting will not function properly. To make things worse, even if two wheels have the same number of cassette ratios, one may differ slightly from another (perhaps due to different manufacturing tolerances) so that when a wheel is changed, often a tweak in cable or derailleur adjustment is required. (Wheels are swapped for various reasons; 1—in race situations with a flat tire, rather than fixing the flat, they often switch the wheel and send the cyclist on their way; 2—many cyclists have multiple wheel sets—one for training, one for racing, and/or one or more with different tires for various riding needs. If one wheel is different—that is, has different number of speeds, or different tolerances, the cyclist will have bad shifting.)

In more recent years, electronic shifting has also become available. Electronic derailleurs function in a similar manner as index shifted ones, moving from one defined position to another easily and accurately using electronic function instead of cable actuated function. These innovations help greatly with adjustment requirements by taking out the mechanical cable link, however, to date, the electronics do not solve situations for varying number of speeds or the issues with swapping wheels, or issues associated with minor mechanical damage. The present invention addresses these concerns as well as reducing needs for continued adjustment and for higher skills required in set up and making adjustments.

The present invention provides for devices and methods to integrate with electronic shifting that allow the shifting system to sense and automatically adjust to conditions of the bike—thereby reducing the need for periodic maintenance, reducing the skill required for accurate setup, and to overcome limitations of wheel-to-wheel tolerances, as well as cassette differences from one to another (like 9-Speed to 10-Speed to 11-Speed, etc.). his sensing and adaptive correction also allows a cyclist to continue to ride and shift acceptably even if minor damage occurs (such as a derailleur hanger being slightly bent).

Additionally, with automatic position sensing, it is possible to make a more compact arrangement of the cassette cogs, allowing inclusion of more cassette cogs within the same amount of space currently used in conventional cassettes. For instance, the invention may allow inclusion of cogs for 13 speeds in the same space currently required for 11 speeds using conventional shifting techniques using conventional shifting techniques, because space to accommodate minor maladjustment is not required.

Finally, automatic position sensing makes possible greater differences in sprocket size (number of teeth) from one sprocket to the next sprocket, because the system can overshoot a sprocket position slightly to complete the ratio change, then immediately come back to center over the newly selected sprocket.

To accomplish these ends, the device is an electronic derailleur control system for a bicycle that is characterized by having a main control unit and at least one sensor. The main control unit has rider command detection, and a derailleur control. The rider command for a shift is detected and processed by the main control unit, then a shift signal is generated and sent to the derailleur. The derailleur responds by changing position to affect the desired shift. As the shift occurs, the sensor detects actions of moving parts of the bicycle, and provides feedback signals to the main control unit. The main control unit then responds to the feedback, as needed, with commands for minor derailleur adjustment until the feedback signals indicate proper derailleur position. It is preferred that the main control unit also has a learning capability that detects and compiles action data communicated via data signals generated by the sensor compared with position commands given. The main control unit detects in the vibration data, signature vibration patterns generated by the moving parts of the bicycle, and calculates and generates a learned adjustment signal based on the feedback signal patterns such that the control unit changes its adjustment signals generated to the derailleur based on the learned adjustment patterns. The invention encompasses derailleur shifting methods including steps of adjusting derailleur position based on feedback from a sensor, where the sensors may measure vibrations, or proximity, or relative position of components as desired—all of which can assist in indication of alignment/misalignment.

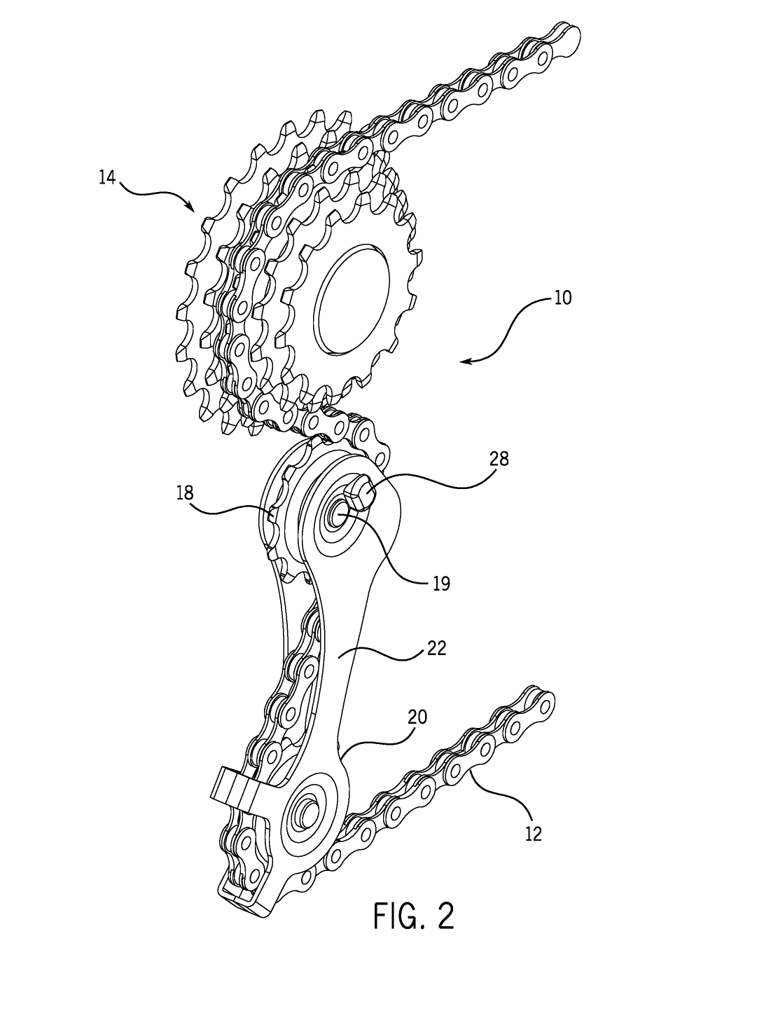

The device and method provide for sensing when the chain, and therefore the derailleur, is aligned with the desired sprocket, then using this information to adaptively locate the derailleur to the sprocket independent of the number of cassette sprockets, independent of manufacturing tolerances, and independent of minor mechanism misalignment. The device and method will sense and accurately position the rear derailleur in alignment with the desired cassette sprocket, independent of distance between cassette sprockets and independent of where that (or another) sprocket was positioned the previous time. When a derailleur is in perfect alignment with a cassette sprocket, the chain, as it travels, comes off the upper guide pulley (sometimes called a jockey wheel or tensioner pulley or idler gear) of the derailleur (see upper guide pulley 18 in FIG. 2) and onto the sprocket in a clean, straight line without any misalignment that can cause rubbing or interference with other cassette sprockets. Automated sensing of that perfect position is a key benefit provided by this invention.

By accurately sensing the ideal engagement of each gear position, and by making micro adjustments on the fly to assure optimal alignment as gears are shifted, it is very practical for the system to adjust to and compensate for any number of gear ratios (9-Speed, 10-Speed, 11-Speed etc.), any wheel change tolerances, and to eliminate the need for periodic derailleur adjustment maintenance.

Two preferred embodiments for achieving the ideal alignment are outlined below, one by sensing variations in the mechanisms for accomplishing the task, and one where relative position of components or proximity with respect to each other is used to accomplish the task. Each embodiment can be used independently, or they could be combined for redundancy if the need arose. Though in some areas specific technologies are indicated, any number of different sensing techniques could be employed for the purposes described here.

### A. Alignment Signature

The invention provides a first method for sensing correct alignment in the nature of an electronic evaluation of the vibration signature. The moving parts of the bike, especially the drivetrain (including the crank, chainrings, sprockets, chain and derailleurs), all have a signature set of vibrations that occur when the bicycle is in motion. The rate and amplitude of the vibrations are, of course, dependent on the speed, the forces, the conditions (wet, dry, muddy, etc.), but there are specific vibrations (sounds) that occur during a shift, and especially when there is misalignment of the derailleur and the selected cassette sprocket. Because these vibrations have particular and recognizable patterns and frequency, they can be sensed and used as feedback in a closed loop control of the derailleur.

In the device and method of the invention, when a shift is commanded (by button or lever, or other action), the main control system commands the derailleur to move in the desired direction (up shift or down shift). The derailleur will immediately move in that direction, and the feedback control then monitors and “watches” for the vibration signatures that indicate that the shift is occurring. As phases of the signatures are sensed, and when the signature of shift completion is recorded, the derailleur feedback control system then causes the derailleur to move in tiny increments as needed to center the derailleur on the desired sprocket, based on the expected vibration signatures and any deviations from the expected vibration signatures. The signatures of misalignment differ slightly when the derailleur is positioned too far up or too far down (axially too far to one side or the other relative to the plane of the particular cassette sprocket). The device and system are designed to sense deviations from the expected vibration signatures, and to calculate according to the deviations the appropriate positioning signal to send to the derailleur control mechanism as a closed loop system to control movement of the derailleur to an optimized position.

The device and method include a vibration filtering module that learns vibration patterns of the bicycle that are unrelated to the derailleur positioning. The filtering allows the main control unit to ignore unrelated vibrations so they do not affect the sensing of the relevant derailleur positioning vibrations, and accordingly, do not affect the generation of the correct positioning signal.

Several technologies are available for such sensors, including, but not limited to pezio technology, microphone, etc., and these sensors may be positioned on the bicycle in a number of different locations depending on the needs of the given bicycle. Examples include: 1) mounting with accompanying circuitry already on board with the electronic rear derailleur; 2) mounting to the bicycle frame near the rear derailleur and rear wheel; and 3) mounting on the derailleur cage near the upper guide pulley.

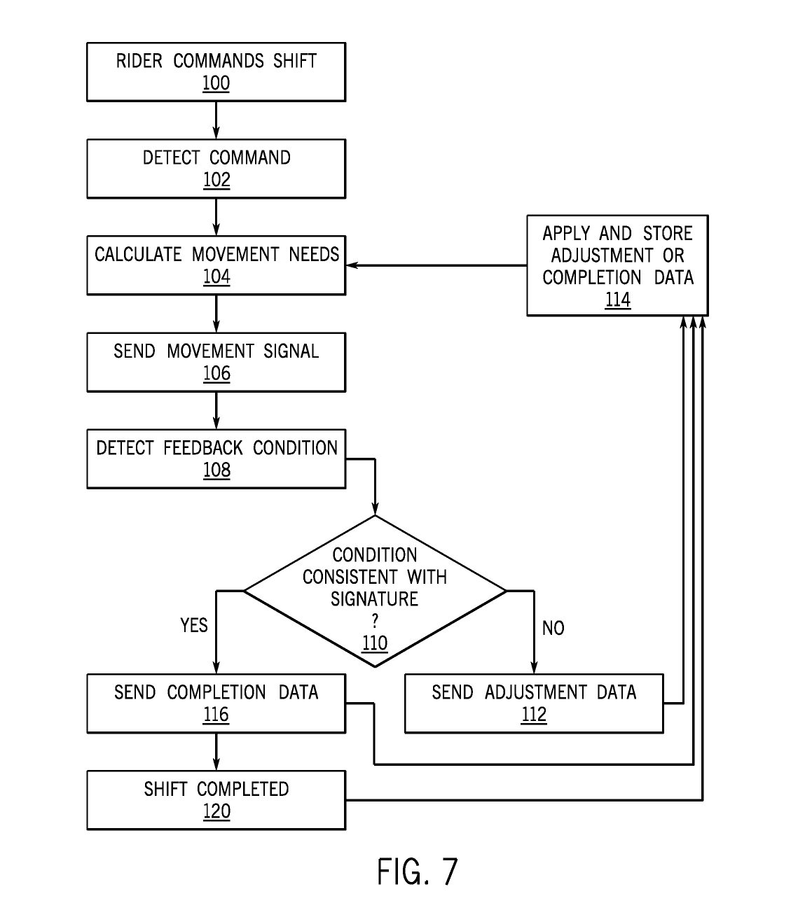

An example with reference to the method steps schematically illustrated in the flow chart herein is provided below. FIG. 7 is a flow chart illustrating steps in a method for electronic derailleur alignment according to an embodiment of the invention.

1. A rider of the bicycle desires to change gears, so they press the shifter lever once to indicate a one gear increment shift (could be up or down shift, the process is essentially the same, though the signature would be sensed in reverse) (step 100). The shifter lever includes an electrical switch which in turn sends the request to the main control unit.

2. The unit detects the command (step 102) and calculates (step 104) the movement needs, that is, the estimated distance for the derailleur to travel from the current gear to the desired gear, and commands the derailleur to move that distance (step 106).

3. As the derailleur moves, a position feedback condition is detected that indicates the movement and returns the signal to the main control unit (step 108). The detection may be accomplished in any number of traditional prior art methods such as pip counting, motor rotation sensor, or linear.

4. The main control unit also monitors the vibration sensor (in this example located at the rear derailleur) (step 108).

5. The signals of both position and vibration are evaluated and compared to the “signature” or pattern of expected positional and vibrational data that is normally expected to occur during the shift (step 110).

6. If the comparison shows successful completion, the data parameters associated with the successful completion may be sent to the adjustment module (step 116) for use in keeping a record of successful adjustment to optionally use to optimize future adjustments. The shift has been completed (step 120) and data on this status may also be sent to and stored in the adjustment module (step 114). If the comparison shows unsuccessful completion (negative condition data such as vibrations or positions outside expected “signature” ranges), then data on the variance (adjustment data) is sent to the adjustment module (step 112) and applied and stored by the adjustment module to direct a recalculation to start a new iteration (step 104).

7. Thus, when the derailleur arrives at the commanded position, the main control unit can tell if 1, the shift actually occurred; 2, if the shift is complete; and 3, if the optimal running position has been achieved. Accordingly, if any of the above is not perfect, the system can adjust slightly, measure the difference and iterate the process to fine tune position to be sure the chain is running as efficiently as possible.

8. Micro adjustments during operation may also be done to assure a continued “best” operation throughout the ride—even when shifts are not being made.

If the above shift were one of many made during the ride, optimizing at the end of the shift will not likely be required since the main control unit will always start the shift process by commanding the last known (learned) perfect position for that gear. If, on the other hand, the rider had experienced a flat tire and got a wheel change where the rear cassette was not the same as the previous one, a command to the last known perfect position would leave the shift not perfect, and the new optimized position would be learned by feedback and iteration. All of this would happen without additional input from the rider and, for the most part, without the rider knowing it was even optimizing. The concept is to optimize each and every shift—even if that optimization is the same position as the last time the chain ran in the particular gear. (Optimization does not require iteration. If the derailleur arrives at the “new” position and the “signature” of proper running is correct, no iteration or added movement is needed.)

The inventive concept is to make the shifts feel like they are open loop (quick), yet adjust quickly via closed loop control when necessary to optimize for conditions.

### B. Sliding Guide Pulley Location

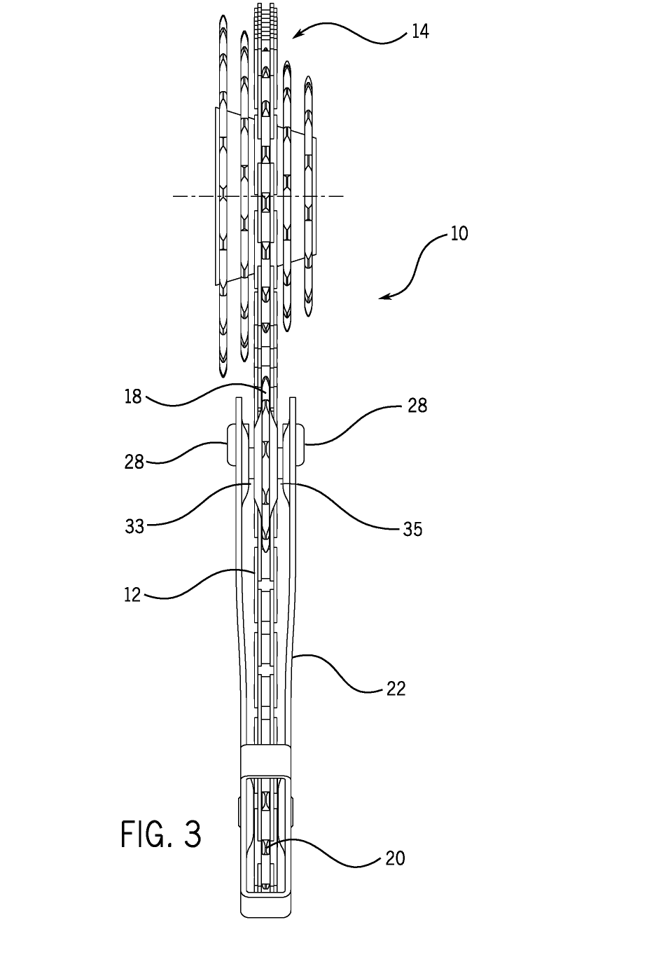

The invention provides a second method for sensing correct rear derailleur alignment by sensing axial position of a sliding top guide pulley of the derailleur cage. A rear derailleur of standard configuration has two guide pulleys on the chain take-up arm, which is often called the derailleur cage, depicted as cage 22 in FIG. 3. It is noted that an illustration of the main body of a rear derailleur 10 has been omitted from the drawings to avoid unintended references to methods of achieving the described motion, and to avoid obscuring views of operations of its parts. Its general position is indicated, however, by reference numeral 10 in the drawings.

The two guide pulleys 18 and 20, depicted in FIG. 3, rotate on their respective axles and are typically constrained to very small movements side to side (axially) by the cage 22 side plates. For this example of the invention, the lower pulley 20 remains constrained in axial motion as in current shifting mechanisms, but the upper pulley 18 is given a degree of freedom to slide axially on its shaft (side to side, a small amount) 33 and 35, with an automated system for measuring its position axially on the shaft. Because of the relatively close proximity of the upper pulley 18 to the sprocket of the cassette 14 (see FIG. 2), the upper pulley 18 will, without other influences, track (or follow) the chain going to that sprocket. The derailleur feedback control system of the invention centers the sliding pulley on its shaft to provide the ideal position. Exemplary technologies for measuring the position under this invention include magnetic, contact, capacitive, and proximity.

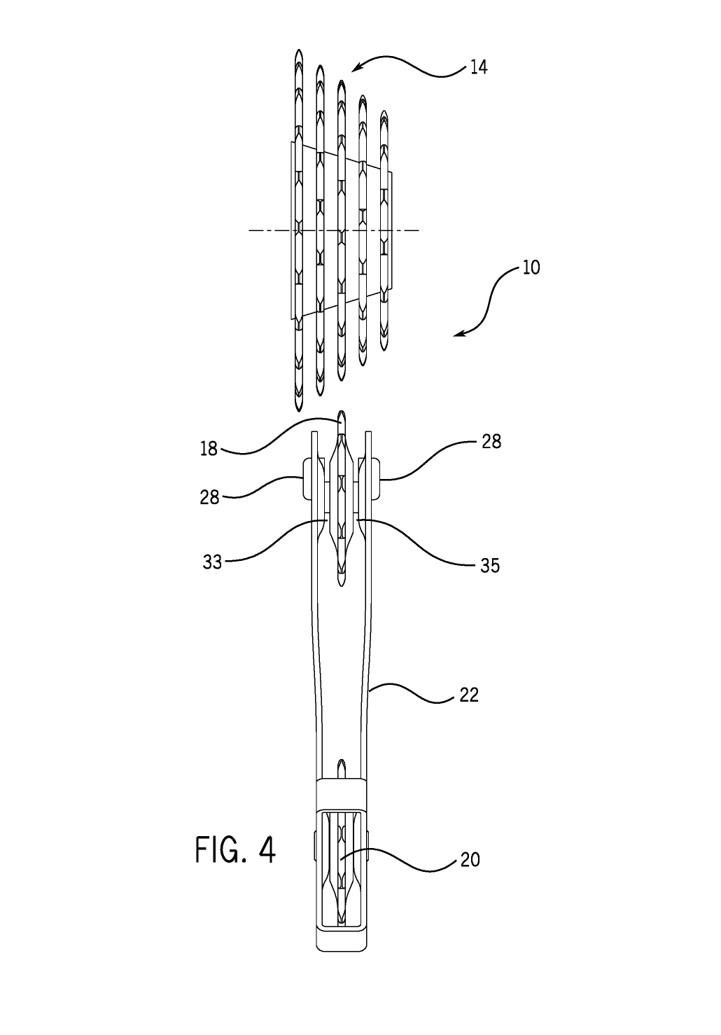

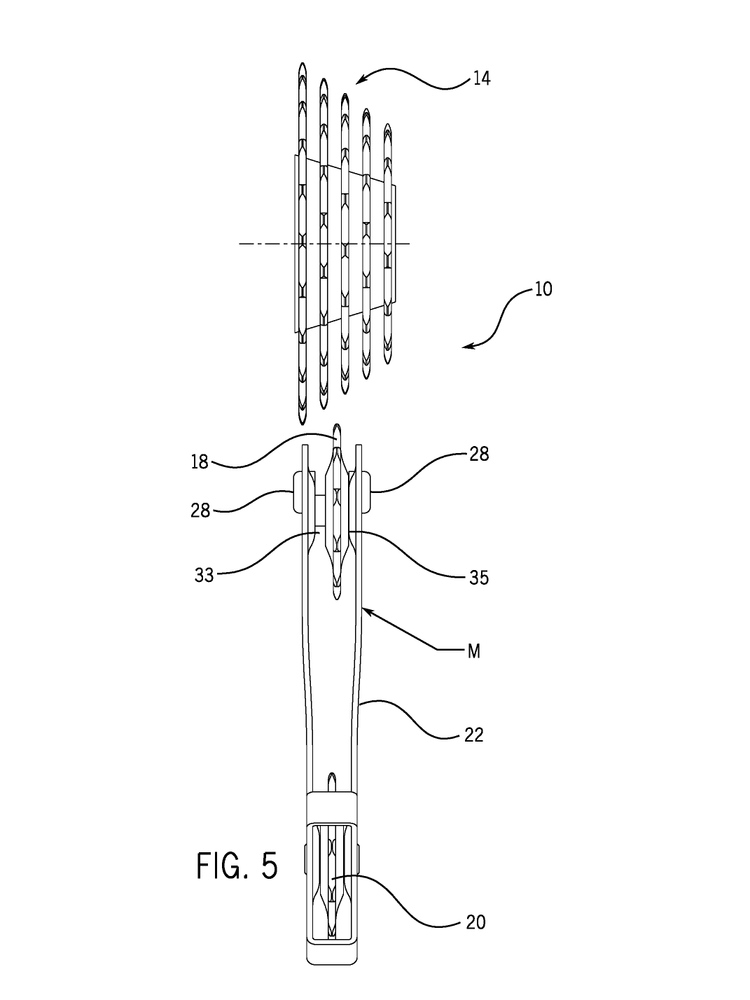

The first preferred embodiment is a simple sensing of contact. If the upper guide pulley 18 is in contact with either side of the cage 22 containing its axial movement, the position is known. If the upper guide pulley 18 is not in contact with either side, it must be floating between, meaning the derailleur and cassette sprocket are in alignment such that the chain runs freely without bias from the derailleur. FIGS. 2-5 show this configuration. The space allowable for the upper guide pulley 18 to move is indicated by 33 and 35. FIGS. 2-4 show the derailleur and guide pulleys aligned with the middle cassette sprocket. FIGS. 4-5 show the same configuration but without showing the chain for clarity so the spaces can be seen clearly. FIG. 5 shows the derailleur mid shift (indicated by the reference letter M) and the tracking of the upper guide pulley 18 pushed against the side plate 22. The pulley must be constrained when shifting, because it is the motion of the pulley that causes the chain to move from one sprocket of the cassette 14 to another. That is seen in FIG. 5 (note added space at 33 when guide pulley 18 moves against cage side plate 22 making space at 35 go to zero). Sensor 28 “sees” this motion and the main control unit uses this information (and more) to control the shift. Once the shift is complete, it is desirable to release the constraint of the upper guide pulley 18 so that the mechanism may run as efficiently as possible (no rubbing of the chain or guide pulleys) thus, according to this method of the invention, once the shift is complete, the main control unit would command movement of the rear derailleur 10 in a manner that once again centers the upper guide pulley between the side plates 22.

A second preferred embodiment includes a series of sensors in the pulley shaft itself—like those used in an electronic caliper as an example—to detect exactly where the upper guide pulley is, and to detect when it is centered axially on the shaft—inferring that it is also centered under the sprocket. The simple example is, of course, the first preferred embodiment.

Again, the method steps schematically depicted in FIG. 7 can represent this embodiment, as follows:

1. A rider of the bicycle desires to change gears, so they press the shifter lever once to indicate a one gear increment shift (could be up or down shift, the process is essentially the same, though the signature would be sensed in reverse) (step 100). The shifter lever includes an electrical switch which in turn sends the request to the main control unit.

2. The unit detects the command (step 102) calculates (step 104) the movement needs, i.e., the estimated distance for the derailleur to travel from the current gear to the desired gear, and commands the derailleur to move the appropriate distance (step 106).

3. During the shift, the two sensors 28 (one at either end of the pulley shaft integrated with the derailleur cage side plates) will go from neither sensing contact (original aligned position FIGS. 2-4) to one sensing contact (as the cage is moved toward the next gear, see FIG. 5) to eventually neither sensing contact (new gear aligned position). In the process, the chain will jump to the next sprocket in the cassette 14 and may cause the pulley to translate across the shaft and into the other side plate (sensing—opposite side as 28) before settling central. The time of contact and the relative position of the derailleur compared to the commanded position are detected (step 108).

4. The time of contact and relative position of the derailleur compared to the commanded position are taken into account by the main control unit as part of the closed loop control (step 110, with comparison of actual position to commanded position, instead of a “signature”).

5. Feedback from the 2 pulley position sensors 28 combined with feedback for derailleur position will be sent to the main unit (step 112 if comparison shows unexpected position, and/or step 116 if position is correct).

6. If the comparison shows successful completion, i.e., the guide pulley runs central on its shaft and is touching neither of the side sensors 28, then positional data associated with the successful completion is sent (step 116). Optionally, the successful completion data may be applied and stored to be considered in calculating future shifts (step 114). This free position of the guide pulley indicates proper alignment. Conversely, if the comparison shows unsuccessful completion (the guide pulley touches one of the side sensors 28), then adjustment data is sent to the adjustment module (step 112), to allow the unit continue to iterate derailleur position, applying and storing the adjustment data (step 114) showing what movement needs still exist, for use in calculating the next iteration (step 104).

7. Thus, as in the first one of the two main embodiments, the system will adjust, on the fly, to new positions as needed. Internal troubleshooting algorithms with the main control unit will compensate and settle if the perfect state is not achieved—for instance, if the desired cassette sprocket is bent and forces the guide pulley to oscillate from one side to the other—or if an axle is not parallel making the guide pulley want to run always against one side—or contamination issues that can cause parts to function differently than the simple case described above.

Each of the method variations and devices described above focus on centering the upper guide pulley 18 as the indication of alignment. When the pulley 18, free to slide axially either direction on its axle (shaft) 19, runs freely in the center, then it is known that the pulley, and therefore the rear derailleur, is not biasing the chain in either axial direction. It is thus established that the chain is in the best position for efficiency and centering under the given circumstances. The device and method then use this established best position as a feedback to control derailleur position.

During a shift, the system monitors the traverse of the upper guide pulley 18 from the center to contact with the side plate. This traverse indicates to the system that the pulley is able to move on its shaft and is now guiding the chain in the correct direction. The system monitors and detects the ratio change (if equipped with speed sensors). The system then monitors and detects movement of the pulley away from the side, as the chain engages the selected sprocket. The control system then centers the derailleur on the selected sprocket to complete the shift.

### C. Enhancements of the Alignment Signature and Sliding Guide Pulley Location Systems

In both the Alignment Signature (A) and Sliding Guide Pulley Location (B) systems and devices described above, the invention provides a number of adaptations to allow improvements to quickly, accurately and repeatably make the desired shifts. Adaptations include: recording the exact locations for each sprocket, in order to shorten the time to detect them in future shifts; adaptively determining how many gear ratios are present by detecting and recording the distance traveled for each gear shift; and employing setup modes in the electronic controls, to provide and use a “learning” setting to allow the system to search out, detect, and record initial positions of sprockets and pulleys, and ideal travel stops for the parts of the control mechanism. Such a system may or may not incorporate physical hard stops at the end of stroke (as currently done with “High” and “Low” travel stop screws) on typical rear derailleurs.

Additional improvements may include additional sensors such as wheel speed and crank speed sensors that allow the system to detect, calculate, and record the definitive gear ratio, so that the system will be able to detect exactly when a shift occurs. Such sensors also are used to anticipate frequency of pertinent vibrations, and thus enable filtering out of superfluous “noise” vibrations that are unrelated to the functioning of the shifting mechanism. A benefit of these invention features is to lessen demands on electronic processors, thus enhancing memory capabilities and shortening processing time. The additional benefit to the rider is, of course, faster and more accurate shifting with less time or skill required for setup. These benefits allow the system to shorten the time needed to determine the appropriate signals to send to the shifting mechanism to properly center the chain on the cassette sprocket.

A preferred embodiment may include an alternative system design, method or device that operates independently of a rider command. Instead of relying upon rider input for initiating a shift, the command for a shift instead may be initiated by a system-generated signal. The system-generated signal may, in a preferred embodiment, be automatically generated by settings and instructions stored in a memory of the main control unit, and the automatic generation may be triggered by feedback on bicycle operating conditions, completely independently of rider command. For example, the hardware and software of the main control unit or modules thereof may be specially programmed and structured to generate a derailleur shift command based on the bicycle conditions such as a particular speed or pedaling cadence. Inputs from sensors installed on the bicycle may be detected and communicated to the main controller on conditions such as speed, pedaling cadence, force, bicycle riding incline, or other conditions or performance variables, and thresholds for initiation of such automated shifts based on the levels of such inputs may be programmed in to the memory of the system.

The adaptability of this kind of closed loop system enables a cyclist to easily make some shifts that are not practical using conventional shifting devices and mechanisms. For instance, using current systems, when one or two ratio steps (cassette sprocket sizes) are large compared to the others (meaning the sprocket size difference for one step is disproportionately large), current systems struggle to make all the shifts reliably and quickly; either the big step is accomplished properly while some other steps suffer, or vice versa. The adaptability features of the device and method taught herein enable settings to cause the rear derailleur to over-shoot a ratio step slightly, so as to cause the selected shift to occur quickly, and then to come back and re-center immediately to make the shift engage reliably and smoothly.

The device and method also enable use of cyclist feedback for troubleshooting. For example, the system is adapted to provide feedback that alerts the cyclist to a detected problem that will require attention, such as a bent derailleur hanger, weeds stuck in the gears, bent gear teeth or other things. A bent derailleur hanger is a common problem. This bent hanger is detected by the system when the sensors determine that the distance between ratios is not the same for each gear change, or when the sensors cannot detect the ideal position at all. Then a signal is generated that triggers a communication to the cyclist. Similarly, presence of debris such as grass or weeds or dirt in the derailleur mechanism is detected by the sensors and the system generates signals to the cyclist and/or to the derailleur control system to alert the cyclist to the problem, and make automated adjustments to help compensate for the problem. The device and method allow the bicycle system to diagnose and warn the cyclist of potential problems, and to compensate for those problems, to some extent, until they are fixed.

These benefits of the invention relating to feedback to the cyclist are not offered by prior art devices and methods; nor are the invention's abilities to automatically allow the derailleur system and cyclist to compensate, adapt, and (to some extent, depending on the degree of damage) continue to function, in spite of an existing problem.

To summarize, key points in the described invention include: (a) automatic action of the derailleur to “find” the perfect position for each cassette sprocket as the “gears” are shifted—independent of the number of gears, the ratios of the gears, and any manufacturing or positional tolerances; (b) use of vibration (sound and/or other vibrations) as a signature to determine gear alignment; (c) sensing the position of a sliding idler or pulley to determine gear alignment; (d) adaptability of the system to adjust position and continue to make good shifts even with minor tweaks such as a bumped or slightly bent derailleur, debris (like grass, weeds or dirt) caught in the mechanisms, etc.; (e) ability to make larger shift steps than traditional systems because the system can over-shoot the next selected position then come back and re-center after the shift has occurred; and (f) the added information available from the embodiments herein will allow the bicycle system to diagnose and warn the rider of potential problems as well as to compensate for those problems (to some extent) until they are fixed.

### D. Details of System Configuration

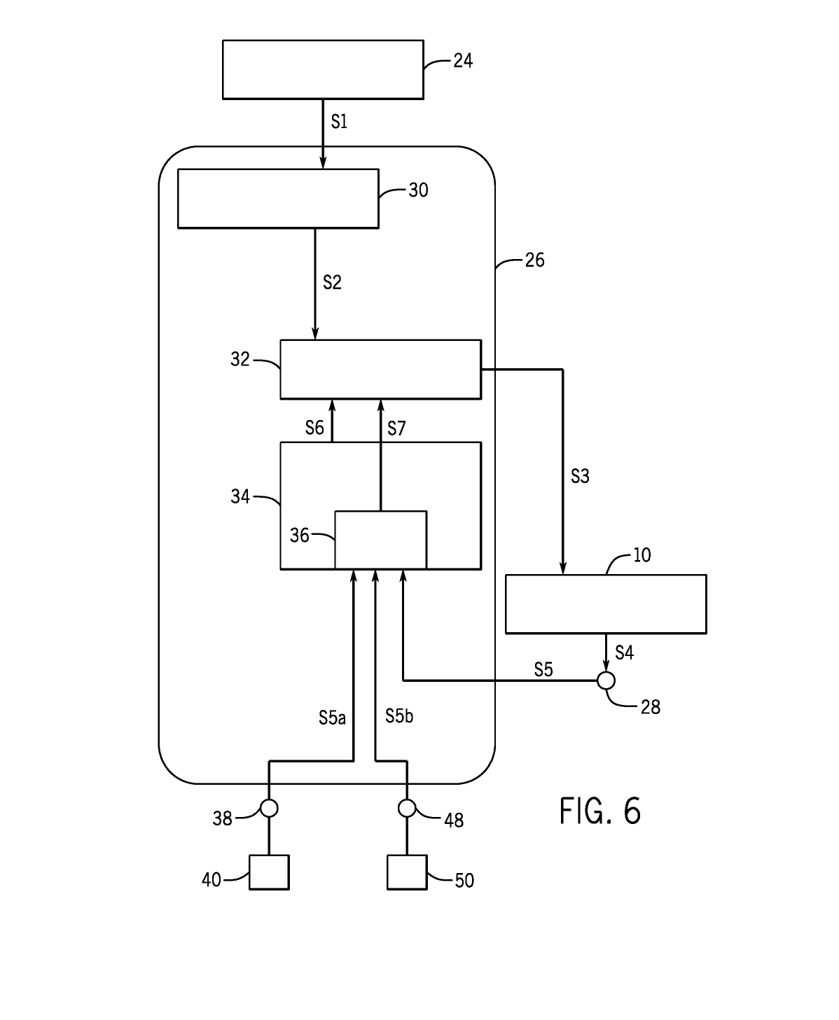

A more detailed description follows of the configuration of the system. FIG. 6 is a schematic diagram showing a system for electronic derailleur alignment according to an embodiment of the invention, and showing connections and operations of its components. A rider of the bicycle desires to change gears, so the rider will press the rider-activated shift command actuator 24 provided as a part of the device on a bicycle ridden by the rider. For example, the actuator 24 can be a shifter lever that is moved once to indicate a one gear increment shift. Preferably, the actuator may be a mechanical lever or push-button of known types that allow the rider to enter a command for the derailleur to shift the chain from one sprocket to another.

The actuator 24 preferably may be connected to a switch connected to wiring, or by wireless communication connection means, to communicate the rider shift command signal S1 to the main control unit 26 via the signal connection or route shown along S1. (It is noted that the “S” references in FIG. 6 may refer either to a path of a signal connection or to the signal that is conveyed along that path).

The main control unit 26 may preferably be a dedicated controller that can include a number of modules structured to functionally execute the operations for controlling the device. The main control unit 26 may preferably be a specially programmed computer or processor configured to functionally execute the operations for controlling the derailleur. In certain embodiments, the main control unit 26 includes a processing subsystem including one or more computing devices having memory, processing, and communication hardware. In accordance with various aspects described herein, examples of processors include microprocessors, microcontrollers, logic devices, gated logic, discrete hardware circuits, and other suitable hardware configured to perform the functionality described herein. The processor or a system or subsystem may execute software that may reside on a computer-readable medium. The computer-readable medium may be a non-transitory computer-readable medium, which would include any suitable medium for storing software and/or instructions that may be accessed and read by a computer.

The main control unit 26 may be a single device or a distributed device, and the functions of the main control unit 26 may be performed by hardware, or by hardware configured by software. The main control unit 26 is in communication, directly or indirectly, with any sensor, actuator, signal route (datalink), or network connection, in the system via wired or wireless electronic communication or signaling means that are known in the art.

As shown in the example depicted in FIG. 6, the main control unit 26 may preferably include at least the following modules (these modules may be units or subsystems, interchangeably) structured to functionally execute the operations for controlling the derailleur: a rider command detection unit or module 30; a shift signal generator unit or module 32; an adjustment unit or module 34; and a learning unit or learning module 36. A derailleur control unit controls movement of the derailleur, and may preferably include the detection module 30, the generator module 32, and the adjustment module 34, or may be comprised of a single unit or module that performs all the functions of these modules. Each of the modules may preferably include non-transitory memory, processing, and communication hardware and software structured to perform the tasks described herein.

The tasks performed by the main control unit 26 or one or more of its modules would include at least: receiving and interpreting feedback signals comprising data from one or more sensors located on or near parts of the bike, including the rear sprockets and parts of the derailleur, and on the operating conditions in the areas of the bike parts (e.g., vibrations); recording such data, e.g., the exact locations for each sprocket in order to shorten the time to detect the locations in future shifts; adaptively determining how many gear ratios are present by receiving, calculating, and recording data on the distance traveled for each gear shift; and employing setup modes, to provide and use a “learning” setting to allow the system to search out, detect, and record data on the initial positions of sprockets and pulleys, and on ideal travel stops for the parts of the control mechanism.

The rider command module 30 may preferably receive the rider shift command signal S1 from the actuator 24, interpret the signal S1, and convey a shift command signal S2 to the shift signal generator module 32. The shift signal generator module 32 conveys a derailleur motion signal S3 to the derailleur 10 to instruct the derailleur to move a particular distance to accomplish the shift. The module 32 can calculate this distance based on an estimated distance for the derailleur to travel from the current gear to the desired gear that has previously been stored in the main control unit 26 or in a module thereof. This derailleur motion signal S3 is received by known electromechanical devices that receive and interpret the signal and impel the derailleur to move the appropriate distance.

As the derailleur moves, one or more sensors gather data to send feedback signals to the main control unit. In FIG. 6, these sensors are schematically represented as a single sensor 28, but it should be understood that there may be in the preferred embodiment a number of sensors 28, 28 positioned to gather data about the derailleur, its environment, and its position relative to the sprockets set, so as to send a number of feedback signals. For example, in a preferred embodiment, a position sensor 28 senses the movement of the derailleur 10 and gathers feedback data (obtaining of data signified by signal route S4). The position sensor 28 then returns a position feedback signal containing the assembled position data, along signal route S5 to the main control unit 26. The signal may include shift completion data indicating successful completion of the shift. The position sensor may be one of a number of known types such as a pip counting sensor, a motor rotation sensor, or a linear distance sensor.

Another sensor represented by reference numeral 28 in FIG. 6 may be a vibration sensor. The vibration sensor is structured to sense vibrations, to record data on the vibrations such as their pattern, timing, and magnitude, to generate a feedback signal containing this vibration data, and to send the signal along signal route S5 to the main control unit 26. The sensors preferably have vibration or position detection means plus hardware and software components including non-transitory memory and electronic communication means for collecting, recording, and sending in a signal the assembled data.

In a preferred embodiment, feedback signals containing data on the position of the derailleur parts, and the vibrations, are evaluated by the main control unit 26, preferably by a module or set of modules in the main control unit that have hardware and software structured and adapted to accept and interpret the feedback signal, and compare it to stored data stored in non-transitory memory. In a preferred embodiment, the stored data includes stored data on past derailleur alignments, that is, stored position data relating to past alignments and whether alignments at a particular position were successful or unsuccessful alignments. A successful alignment is one that did not result in generation of negative alignment data, such as vibration exceeding expected parameters. Stored data may also preferably include other data relating to environmental or operational data relevant to derailleur alignment and adjustment.

In a preferred embodiment, the stored data may include a stored “signature” pattern of vibrations that is expected to occur during normal running operation, or during a normal, successful shift. The “signature” vibration pattern was stored in the main control unit 26 during a “learning” phase as described above. A learning module 36 of the main control unit 26 may store in its memory stored data on past shifts and/or operational or environmental data such as past vibration patterns, to calculate and generate a “signature” pattern for a given condition, and to compare the pattern indicated by the data contained in the feedback signals S5, S5a, and S5b to the “signature” pattern, and thereby generate and send a learned adjustment signal S7 containing adjustment instructions (adjustment data) to the shift signal generator module 32. The learning module 36 may be an optional subsystem of an adjustment module 34 dedicated to pattern comparison. The learning module 36 may store data from many repeated iterations of the feedback cycle to “learn” patterns so as to send a learned adjustment signal S7 that optimizes the shift adjustment instructions based on many data sets gathered during the much iteration.

Optionally, the adjustment module 34, itself, makes the calculations and performs the pattern comparisons to generate and send an adjustment signal S6 containing the adjustment instructions directly to the shift signal generator module 32. The shift signal generator module 32 interprets the data contained in the adjustment signal S6 and/or the learned adjustment signal S7 and applies the adjustment instructions therein to generate an adjustment to the derailleur motion signal S3 (e.g., slightly reducing the amount of motion the derailleur is instructed to make based on feedback). The instructions in signal S3 are then conveyed to the derailleur 10. The known means for making positional adjustments of the derailleur parts are employed to make the derailleur move in accord with the instructions in signal S3, actuated by electromechanical means receiving the signal S3 through a wired or wireless connection with the main control unit 26, preferably via its shift signal generator module 32.

The stored data may include stored “signature” data on conditions detected at other parts of the bike, as well as those at the derailleur 10. For example, as shown in FIG. 6, other parts 40, 50 of the bicycle, such as an area of a front derailleur, may preferably also have additional sensors 38, 48 positioned to detect conditions (such as part positions, or vibrations) in or around the parts 40, 50, and convey a feedback signal via connections S5a and S5b to the main control unit 26. This feedback also may be used in calculating an appropriate adjustment signal S6 or S7.

Disclosed is an embodiment of an electronic derailleur control system for a bicycle, comprising: a main control unit; and at least one sensor, wherein the main control unit comprises a rider command detection unit, and a derailleur control unit, the rider command detection unit detects a derailleur shift command signal generated by a rider, the derailleur control unit controls a shift of a derailleur of the bicycle based on the shift command signal, by communicating the shift command signal to the derailleur, which changes a derailleur shift position based on the shift command signal, the sensor detects vibrations generated by moving parts of the bicycle, the sensor generates a feedback signal to the derailleur control unit based on the detected vibrations, the derailleur control unit calculates a required derailleur adjustment based on the feedback signal, the derailleur control unit generates an adjustment signal to the derailleur based on the required adjustment, and the derailleur adjusts the shift position based on the adjustment signal.

Also disclosed is such a system according wherein the derailleur control unit further comprises a learning unit that detects and compiles vibration data communicated to the learning unit via data signals generated by the sensor, detects in the vibration data signature vibration patterns generated by the moving parts of the bicycle, and calculates and generates a learned adjustment signal based on the vibration patterns to the derailleur control unit, and wherein the derailleur control unit changes its adjustment signal generated to the derailleur based on the learned adjustment signal.

Further disclosed is an embodiment of an electronic derailleur control system for a bicycle, comprising: a main control unit; and at least one sensor, wherein the main control unit comprises a rider command detection unit, and a derailleur control unit, the rider command detection unit detects a derailleur shift command signal generated by a rider, the derailleur control unit controls a shift of a derailleur of the bicycle based on the shift command signal, by communicating the shift command signal to the derailleur, which changes a derailleur shift position based on the shift command signal, the sensor detects senses position of a chain guide wheel on the bicycle derailleur, the sensor generates a feedback signal to the derailleur control unit based on the detected chain guide wheel position, the derailleur control unit calculates a required derailleur adjustment based on the feedback signal, the derailleur control unit generates an adjustment signal to the derailleur based on the required adjustment, and the derailleur adjusts the shift position based on the adjustment signal.

Further disclosed is an embodiment of an electronic derailleur control system for a bicycle, comprising: a specially programmed processor operatively connected to a derailleur of the bicycle and to at least one sensor of the bicycle; and a non-transitory computer readable storage medium having a plurality of machine-readable instructions configured to store instructions executable by the processor to: receive feedback data from the sensor on a performance parameter; analyze the feedback data to evaluate satisfaction of a stored conditional relating to the performance parameter; calculate a required derailleur adjustment based on satisfaction of the conditional; and control a shift of a derailleur to achieve the required derailleur adjustment based on the satisfaction of the conditional.

Further disclosed is an embodiment of a method for controlling a derailleur of a bicycle, comprising: providing an electronic derailleur control system for the bicycle including a main controller and at least one sensor, the main controller comprising a rider command detector, and a derailleur controller, and the main controller being operatively connected to the derailleur, wherein the rider command detector detects a derailleur shift command signal provided by a rider of the bicycle, the derailleur controller controls a shift of a derailleur of the bicycle based on the shift command signal, by communicating the shift command signal to the derailleur, which changes a derailleur shift position based on the shift command signal, the sensor detects vibrations generated by moving parts of the bicycle, the sensor generates a feedback signal to the derailleur controller based on the detected vibrations, the derailleur controller calculates a required derailleur adjustment based on the feedback signal, the derailleur controller generates an adjustment signal to the derailleur based on the required adjustment, and the derailleur adjusts the shift position based on the adjustment signal.

Further disclosed is an embodiment of a method for controlling a derailleur of a bicycle, comprising: providing an electronic derailleur control system for a bicycle including a main controller and at least one sensor, the main controller comprising a rider command detector, and a derailleur controller, and the main controller being operatively connected to the derailleur, wherein the rider command detector detects a derailleur shift command signal provided by a rider, the derailleur controller controls a shift of a derailleur of the bicycle based on the shift command signal, by communicating the shift command signal to the derailleur, which changes a derailleur shift position based on the shift command signal, the sensor detects senses position of a chain guide wheel on the bicycle derailleur, the sensor generates a feedback signal to the derailleur controller based on the detected chain guide wheel position, the derailleur controller calculates a required derailleur adjustment based on the feedback signal, the derailleur controller generates an adjustment signal to the derailleur based on the required adjustment, and the derailleur adjusts the shift position based on the adjustment signal.

### LIST OF REFERENCE NUMERALS

10 derailleur
12 chain
14 cassette
16 front derailleur
18 upper guide pulley
19 axle of upper guide pulley
20 lower pulley
22 cage
24 rider-activated shift actuator
26 main control unit
28 sensor
30 rider command module
32 shift signal generator module
33 space on first side of axle 19
35 space on second side of axle 19
36 learning module
38 additional sensor
40 additional bicycle part
48 additional sensor
50 additional bicycle part
S1 rider signal
S2 shift command signal
S3 derailleur motion signal
S4 condition data/signal
S5, S5a, S5b feedback signals
S6 adjustment signal
S7 learned adjustment signal

What is claimed is:

1. An electronic derailleur control system for a bicycle, comprising:
a main control unit; and
at least one sensor, wherein
the main control unit comprises
a rider command detection unit, and
a derailleur control unit,
the rider command detection unit detects a derailleur shift command signal generated by a rider,
the derailleur control unit controls a shift of a derailleur of the bicycle based on the shift command signal, by communicating the shift command signal to the derailleur, which changes a derailleur shift position based on the shift command signal,
the sensor detects vibrations generated by moving parts of the bicycle,
the sensor generates a feedback signal to the derailleur control unit based on the detected vibrations,
the derailleur control unit calculates a required derailleur adjustment based on the feedback signal,
the derailleur control unit generates an adjustment signal to the derailleur based on the required adjustment, and
the derailleur adjusts the shift position based on the adjustment signal.

2. A system according to claim 1, wherein the derailleur control unit further comprises a learning unit that
detects and compiles vibration data communicated to the learning unit via data signals generated by the sensor,
detects in the vibration data signature vibration patterns generated by the moving parts of the bicycle, and
calculates and generates a learned adjustment signal based on the vibration patterns to the derailleur control unit, and
wherein the derailleur control unit changes its adjustment signal generated to the derailleur based on the learned adjustment signal.

3. An electronic derailleur control system for a bicycle, comprising:
a main control unit; and
at least one sensor, wherein
the main control unit comprises
a rider command detection unit, and
a derailleur control unit,
the rider command detection unit detects a derailleur shift command signal generated by a rider,
the derailleur control unit controls a shift of a derailleur of the bicycle based on the shift command signal, by communicating the shift command signal to the derailleur, which changes a derailleur shift position based on the shift command signal,
the sensor detects senses position of a chain guide wheel on the bicycle derailleur,
the sensor generates a feedback signal to the derailleur control unit based on the detected chain guide wheel position,
the derailleur control unit calculates a required derailleur adjustment based on the feedback signal,
the derailleur control unit generates an adjustment signal to the derailleur based on the required adjustment, and the derailleur adjusts the shift position based on the adjustment signal.

4. An electronic derailleur control system for a bicycle, comprising:
a specially programmed processor operatively connected to a derailleur of the bicycle and to at least one sensor of the bicycle; and
a non-transitory computer readable storage medium having a plurality of machine-readable instructions configured to store instructions executable by the processor to:
receive feedback data from the sensor on a performance parameter;
analyze the feedback data to evaluate satisfaction of a stored conditional relating to the performance parameter;
calculate a required derailleur adjustment based on satisfaction of the conditional; and
control a shift of a derailleur to achieve the required derailleur adjustment based on the satisfaction of the conditional.

5. A method for controlling a derailleur of a bicycle, comprising:
providing an electronic derailleur control system for the bicycle including a main controller and at least one sensor, the main controller comprising a rider command detector, and a derailleur controller, and the main controller being operatively connected to the derailleur, wherein
the rider command detector detects a derailleur shift command signal provided by a rider of the bicycle,
the derailleur controller controls a shift of a derailleur of the bicycle based on the shift command signal, by communicating the shift command signal to the derailleur, which changes a derailleur shift position based on the shift command signal,
the sensor detects vibrations generated by moving parts of the bicycle,
the sensor generates a feedback signal to the derailleur controller based on the detected vibrations,
the derailleur controller calculates a required derailleur adjustment based on the feedback signal,
the derailleur controller generates an adjustment signal to the derailleur based on the required adjustment, and
the derailleur adjusts the shift position based on the adjustment signal.

6. A method for controlling a derailleur of a bicycle, comprising:
providing an electronic derailleur control system for a bicycle including a main controller and at least one sensor, the main controller comprising a rider command detector, and a derailleur controller, and the main controller being operatively connected to the derailleur, wherein
the rider command detector detects a derailleur shift command signal provided by a rider,
the derailleur controller controls a shift of a derailleur of the bicycle based on the shift command signal, by communicating the shift command signal to the derailleur, which changes a derailleur shift position based on the shift command signal,
the sensor detects senses position of a chain guide wheel on the bicycle derailleur,
the sensor generates a feedback signal to the derailleur controller based on the detected chain guide wheel position,
the derailleur controller calculates a required derailleur adjustment based on the feedback signal,
the derailleur controller generates an adjustment signal to the derailleur based on the required adjustment, and the derailleur adjusts the shift position based on the adjustment signal.
